(19) United States
(12) Patent Application Publication
(10) Pub. No.: US 2008/0292917 A1
(43) Pub. Date: Nov. 27, 2008

(54) PORTABLE ELECTRONIC DEVICE WITH INTEGRATED FUEL CELL

(75) Inventor: Igor BIMBAUD, Chanceaux sur Choisille (FR)

Correspondence Address: Mario Donato, Jr.;STMicroelectronics, Inc., 1310 Electronics Dr., Carrollton, TX, 75006, US

(73) Assignee: STMicroelectronics SA, Montrouge (FR)

(21) Appl. No.: 11/752,499

(22) Filed: May 23, 2007

(51) Int. Cl. H01M 8/04; H01M 8/00

(52) U.S. Cl. 429/13; 429/26

(57) ABSTRACT

A portable electronics device includes a base member containing electronic circuitry for device operation and configured for handheld use. A display is operatively connected to and driven by the electronic circuitry and pivotally connected to the base member. The display includes a backside that is typically not handled by a user when the device is in use. A fuel cell unit is secured to the backside of the display and operatively connected to the electronic circuitry and display for powering the device. The anode of the fuel cell is juxtaposed at the backside of the display and the cathode is oriented outward from the backside facilitating unobstructed air breathing, evacuation of water and heat dissipation.

### FIELD OF THE INVENTION

The present invention relates to portable electronic devices, and more particularly, this invention relates to portable electronic devices having an integrated fuel cell.

### BACKGROUND OF THE INVENTION

Fuel cells have become increasingly more popular each year since the late 1950's when they were first used to power different devices in space exploration vehicles. Large fuel cells are now used to power cars and buses, and smaller fuel cells power electronic devices, including cellular phones and laptop computers. Thus, fuel cells range in size and can be used for a myriad of different applications. The larger fuel cells typically are designed as large stacks of individual fuel cells that power cars or other vehicles. The smallest fuel cells can be formed on silicon and used to power other silicon based devices, even those fabricated on the same silicon chip as the fuel cell itself. Examples of silicon based fuel cells are disclosed in commonly assigned U.S. Patent Publication Nos. 2003/0003347 to D'Arrigo et al.; 2004/0142214 to Priore et al.; and 2006/0073368 to Chiu, the disclosures of which are hereby incorporated by reference in their entirety.

Fuel cells typically produce electricity from an electrochemical reaction that exists between a fuel gas, such as hydrogen, and oxygen provided from the air. In the larger fuel cell devices or systems, a stack of thin, flat and planar configured fuel cells are layered together. The electricity produced by a single fuel cell is combined with other individual, stacked fuel cells to provide enough power for a vehicle or other application that requires far greater power than an individual fuel cell can provide.

Usually, a fuel cell includes an ion exchange electrolyte formed as a polymer membrane that is positioned or sandwiched between two thin “catalyst” layers operative with anode and cathode electrodes that start the reactions and produce the electricity. Hydrogen is fed to the fuel cell and contacts a first catalyst layer as an anode electrode. Hydrogen molecules release electrons and protons. The protons migrate through the electrolyte to the cathode electrode typically as part of a second catalyst layer and react with oxygen to form water. The electrons that are separated from the protons at the anode cannot pass through the electrolyte membrane, and thus, travel around it, creating an electrical current.

There are many different types of fuel cells, typically depending on the type of electrolyte positioned between the electrodes. For example, many fuel cells use a polymer electrolyte membrane (PEM) and are termed PEM fuel cells. Other fuel cells can be classified as direct methanol, alkaline, phosphoric acid, molten carbonate, solid oxide, and regenerative fuel cells. Regenerative fuel cell technology also produces electricity from hydrogen and oxygen and generates heat and water as byproducts, similar to other fuel cells, such as the PEM fuel cells. The regenerative fuel cell systems, however, can also draw power from a solar cell or other source to split water formed as a byproduct into both oxygen and the hydrogen fuel using electrolysis. NASA is one group that has been active in developing this technology.

Polymer electrolyte membrane (PEM) fuel cells are the better known and more popular fuel cells because they do not require corrosive fluids, and use a solid polymer as an electrolyte, typically with some type of porous electrode that may contain a platinum catalyst. Usually, the PEM fuel cells receive pure hydrogen from a fuel supply such as a fuel cartridge or some type of other fuel storage system. The PEM fuel cells typically operate at low temperatures, around 80° C. (176° F.), which allows them to start quickly with less warm-up time. This results in reduced wear, increased durability, greater power per pound of fuel gas, and overall better operation. Usually some type of mobile metal catalyst is operative with the anode, for example, platinum, and separates the hydrogen's electrons and protons. Another catalyst could be operative with the cathode to aid in the reaction using oxygen and air.

Some fuel cells store hydrogen chemically using a metal hydride or carbon nano-tubes, which are microscopic tubes of carbon, for example, two nanometers across. Whatever type of hydrogen storage or generation is used, however, what distinguishes the fuel cell particularly is the use of an ion exchange electrolyte, such as a polymer electrolyte membrane (PEM), operative as a proton exchange membrane. These types of membranes are typically formed as an ion-exchange resin membrane and can be applied as a very thin film, sometimes even poured or wiped on. PEM is usually made from perfluorocarbonsulfonic acid, sold under the tradename “Nafion,” phenolsulfonic acid, polyethylene sulfonic acid, polytrifluorosulfonic acid, and similar compounds. Other examples may include those compounds discussed in the incorporated by reference '368, '347 and '214 published patent applications. Some porous carbon sheets are impregnated with a catalyst, such as platinum powder, and placed on each side of this resin membrane to serve as a gas diffusion electrode layer. This structure and assembly is usually termed a membrane-electrode assembly (MEA) by many skilled in the art.

A flow divider is often operative at the electrodes and anode and cathode. A flow divider at the anode forms a fuel gas passage on one side of the MEA. An oxidizing gas passage can be formed on the other side of the MEA using a flow divider. Distribution plates, separation plates, or other assemblies, including silicon structures as disclosed and claimed in the above-identified '368, '214 and '347 incorporated by reference published patent applications could be operative as flow dividers.

When the fuel cells as described are used for powering portable electronic devices cell such as a notebook computer or PDA, the fuel cell configuration relative to the electronic device could become problematic because the layout of the fuel cell within or on the portable electronic device may not allow the fuel cell to breath when the fuel cell or one area of it is handled by the user. It is possible that a user's hand while handling the device will seal the fuel cell from breathing properly. As a result, air flow into the fuel cell and water vapor discharged from the fuel cell become inefficient.

There have been some proposals for fuel cells and a portable electronics device such as a portable computer, for example, as disclosed in U.S. Patent Publication No. 2005/0089743. In this portable computer, a direct methanol fuel cell (DMFC) is integrated with the portable computer, which includes a display unit rotatably coupled to a main base unit. The display unit includes a display panel. A liquid fuel tank and a direct methanol fuel cell is positioned on the backside of the display panel. A liquid supply device is positioned under the keyboard to circulate and output from the DMFC to the fuel tank. The fuel cell is positioned at the back of the display, but located within an interior section of this backside. The liquid supply device is supplied under the keypad within the housing of the portable computer. Thus, there is no provision for adequate heat exchange and airflow, although there is a provision for some water discharge with such system.

### SUMMARY OF THE INVENTION

A portable electronics device includes a base member having electronic circuitry for device operation and configured for handheld use. A display member has a display that is operatively connected to and driven by the electronic circuitry. The display member is pivotally connected to the base member and movable from a closed position and into an open position at which a user can view the display. The display member includes a backside that is typically not handled by a user when the device is in use. A fuel cell unit is secured to the backside of the display member and operatively connected to the electronic circuitry and display for powering the display and electronic circuitry. The anode of the fuel cell is juxtaposed at the backside of the display member and the cathode is oriented outward from the backside to facilitate unobstructed air breathing, evacuation of water and heat dissipation.

A fuel supply is carried by the base member and operatively connected to the fuel cell unit for supplying fuel to the fuel cell unit. The fuel cell unit can be formed as a plurality of fuel cell elements, each comprising an anode and cathode terminal. The fuel cell elements can be serially connected to each other.

The fuel cell unit includes an output electrical connection to which the display and electronic circuitry are connected. The fuel cell unit can also be formed with at least one silicon substrate on which the cathode and anode are formed.

In yet another aspect, a cartridge adapter port is formed within the base member and configured for receiving a fuel cartridge as the fuel supply for supplying fuel to the fuel cell unit. The base member includes opposing sides and the cartridge adapter port is positioned on the side of the base member to facilitate manual insertion of a fuel cartridge. A keypad is carried by the base member and operative with the electronic circuitry and display for entering characters that can be displayed. The keypad is covered and protected by the display member when in the closed position. The electronic circuitry, keypad and display are operative as a portable computer. The base unit includes a rear edge on which the display pivotally mounts.

### BRIEF DESCRIPTION OF THE DRAWINGS

Other objects, features and advantages of the present invention will become apparent from the detailed description of the invention which follows, when considered in light of the accompanying drawings in which:

FIG. 1 is a diagrammatic view showing basic components of a fuel cell, including the anode, cathode and PEM positioned between the anode and cathode.

FIG. 2 is another, diagrammatic view of a fuel cell and showing details of a silicon layer, insulator, electrolyte and current collectors.

FIG. 3 is a fragmentary, perspective view of a portable electronic device that includes an integrated fuel cell on the back of the display and a fuel cartridge positioned on the side of the base member, in accordance with a non-limiting example of the present invention.

FIG. 4 is a fragmentary, partial schematic circuit diagram of a system architecture that could be used in accordance with a non-limiting example of the present invention.

FIG. 5 is a fragmentary, perspective view of a silicon fuel cell core unit (FCCU) that could be used in accordance with a non-limiting example of the present invention.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

In accordance with a non-limiting example of the present invention, fuel cell elements are arranged to form a fuel cell unit in an advantageous configuration on a portable electronic device such as a communications device, a small laptop computer or other portable device, which typically includes a base member, including a keypad thereon, and a display member that typically is pivotally attached to the base member. Proper airflow to the fuel cell unit is arranged no matter how the user is handling the electronic device. For example, the portable electronic device may include the base member having the keypad and the pivotally mounted display. Typically, users find the most common and comfortable way to handle such a device is to place the base member on the table or carry the base member while viewing the display. The backside of the display is not used by the user to handle the device. Thus, in accordance with a non-limiting example of the present invention, the fuel cell unit is mounted on the backside of the display with the cathode side oriented to face outward from the device to allow air breathing, heat dissipation and water management. A fuel cartridge to supply the fuel can be mounted on the side of the base member.

It should be understood that future battery improvements are not expected to provide enough energy density to meet the requirements of the new generation of portable devices, for example, cell phones, PDA's, MP3 players, DSC's and similar portable devices. Micro fuel cell technology is a promising technology that can respond to this requirement for more embedded energy in such devices.

A micro fuel cell is a power generator and does not store the chemical solution needed to perform the electrochemical reaction. The reactant is fed continuously on the anode side of the fuel cell, where the hydrogen molecule is separated to produce a proton (H+) and electron (e⁻). The protons move through the membrane of the fuel cell, typically a Proton Exchange Membrane (PEM), and are transported to the cathode. The electrons, on the other hand, are collected and circulate via an electrical circuit. On the cathode side the proton and the electron are recombined with the oxygen from air to generate water molecules.

A fuel cell requires oxygen from the ambient air for its operation, which is also termed “breathing” by some skilled in the art. The basic chemical reaction of the fuel cell is:

On the anode: H2 [symbol] 2H⁺+2e (1)

On the cathode: ½ O₂ 2H⁺+2e [symbol] H₂O (2)

With a first order derivation versus time of the reaction at the cathode, it is possible to obtain:

½ dO₂/dt+2dH⁺/dt+2de/dt [symbol] dH₂O/dt (3),

where de/dt is the electrical current generated by the fuel cell whereas dO₂/dt is the flow of oxygen at the cathode.

This relation shows that the electrical current I=de/dt is directly proportional to the flow of hydrogen and the flow of oxygen. Therefore, the performance of the fuel cell is closely dependent on the quality of the available flow of air on the cathode side of the fuel cell system. The equation (2) also shows that the fuel cell generates water molecules. If excess water accumulates on the cathode, the fuel cell is flooded and the air breathing is reduced. As a result, the electrical performance is degraded, and the fuel cell system can even stop by itself.

In many fuel cells, the average electrical efficiency of the fuel cell is about 50%. The heat dissipation allows the water accumulated on the cathode to evaporate, depending on design. In order to avoid condensation and moisture in the system, the water can be evaporated outside the system. With this type of system, a proper access to the air is necessary during the operation of the fuel cell.

The average power consumption of a low end GSM cell phone can be estimated to be about 1 W for a display size of about 30×30 mm=9 cm². The projection for the new generation multimedia cell phones are about 3 W to even about 5 W for a display size projected of 60×37=22 cm².

Currently, some film microfuel cell systems reach a power density of more than 150 mW/cm². Including the package, the footprint of a 1 W fuel cell is almost 8.6 cm², which is close to the available surface area on the back side of a display used in many portable electronic devices currently available on the market. Assuming the efficiency of the fuel cell is 50%, the weight of the water rejected during 1 hour at 1 W will be about 0.9 g and the dissipation will be about 2.3 W.

A desired fuel cell system will have a power density close to 500 mW/cm². Including the packaging, a 5 W system will have a footprint of about 13 cm². This is about two-thirds (⅔) of the available area on the backside of the many displays used in portable electronic devices that are configured for hand-held operation. Assuming efficiency of the fuel cell is about 50%, the weight of water rejected during 1 hour at 5 W will be about 2.7 g and the dissipation will be about 5 W. The size of the fuel cell system can be very close to the size of the display and the quantity of water and the heat dissipation can be important in the design of such devices. As a result, proper air contact of the cathode is required for correct air breathing, and the adequate electrical performance of the fuel cell with adequate evacuation of water and heat dissipation.

The design of the portable electronic device in accordance with a non-limiting example of the present invention takes into account this constraint and the fuel cell unit can breath and evacuate its heat and water regardless of how the portable device is used, and especially how the device is held by the user.

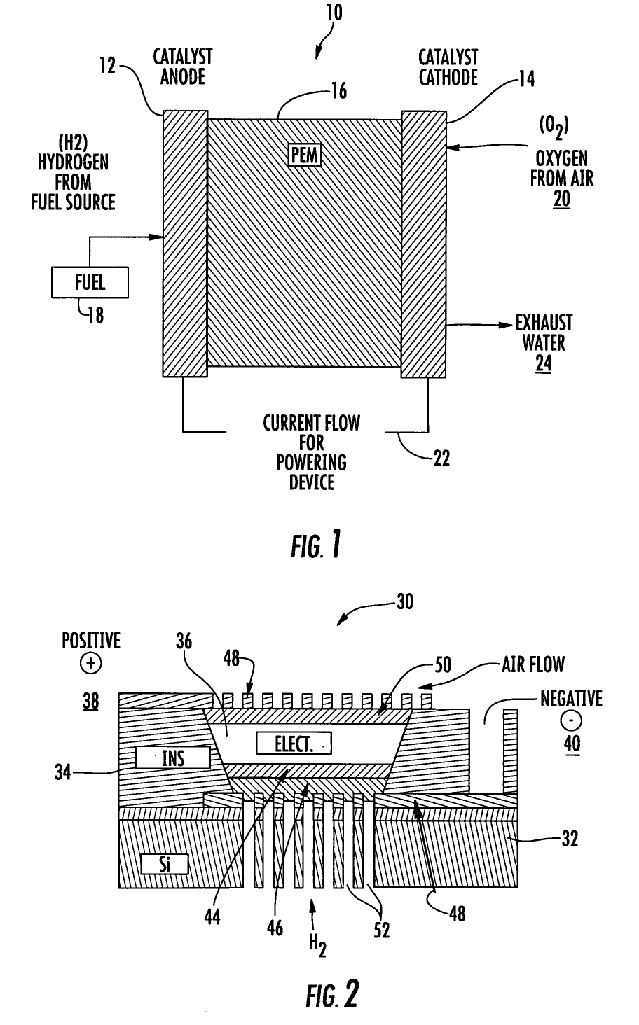

FIGS. 1 and 2 show examples of fuel cells that could be modified for use with non-limiting examples of the present invention.

FIG. 1 illustrates high-level components of a fuel cell 10, showing an anode 12 and cathode 14 separated by the proton exchange membrane (PEM) 16. Both the anode 12 and cathode 14 can be catalysts. Hydrogen from a fuel source 18 is passed through or over the anode 12 while oxygen, for example, from air 20, is passed through or over the cathode 14. The current flows 22 between the anode 12 and cathode 14. Exhaust and water 24 are discharged from the cathode 14.

FIG. 2 is another fragmentary view of a fuel cell showing greater details of a silicon-based fuel cell 30. A silicon layer 32 supports an insulator 34 and electrolyte 36. The positive anode 38 and negative cathode 40 are illustrated together with a lower current collector 42, catalyst 44 and catalyst support 46. An upper current collector 48 and catalyst 50 receive airflow as illustrated. Hydrogen is forced upward through channels 52 in the silicon and air is forced over the current collector 48.

In these two examples, it should be understood that fuel is supplied on the anode 38 and an oxidant is supplied on the cathode 40. These two gases react by use of an electrolyte 36, which remains in the fuel cell. Although different combinations of different fuels and oxidants can be used, typically hydrogen is commonly used as a fuel and can be supplied from a separate fuel cartridge. Oxygen from air is commonly supplied as the oxidant. Other hydrocarbons and alcohols could be used as the fuel and other oxidants such as air, chlorine and chlorine dioxide could be used as the oxidant.

The proton-conducting polymer electrolyte membrane (PEM) is commonly used as an electrolyte and separates the anode and cathode. As noted before, the anode is operative as a catalyst to disassociate hydrogen into protons and electrons. Protons are conducted to the cathode through the membrane while the electrons travel in an external electronic circuit to supply power, such as to a portable electronics device in accordance with a non-limiting example of the present invention. The membrane is usually electrically insulating. Waste product such as the water vapour or liquid water is formed at the cathode. Because the user of the device does not block the cathode interface, the water can evaporate as will be explained in greater detail below.

Different materials and metals can be used for electrode plates, including nickel or other materials that could include carbon nano-tubes, which could be coated with a catalyst such as platinum or nano-iron powders or palladium. Different paper, for example a carbon paper, could separate components from the electrolyte, which could be ceramic or a membrane.

In operation, hydrogen is channelled through different flow plates to the anode on one side of the fuel cell. The oxygen is channelled to the cathode on the other side of the fuel cell, separated by the PEM. Usually at the anode, a catalyst for example, platinum, disassociates the hydrogen ions as protons and negatively charged electrons. The PEM allows the positively charged ions to pass through to the cathode, while the electrons travel along the external circuit to the cathode. At the cathode, the electrons and protons combine with oxygen to form water, which could flow from the fuel cell as water vapour as it evaporates.

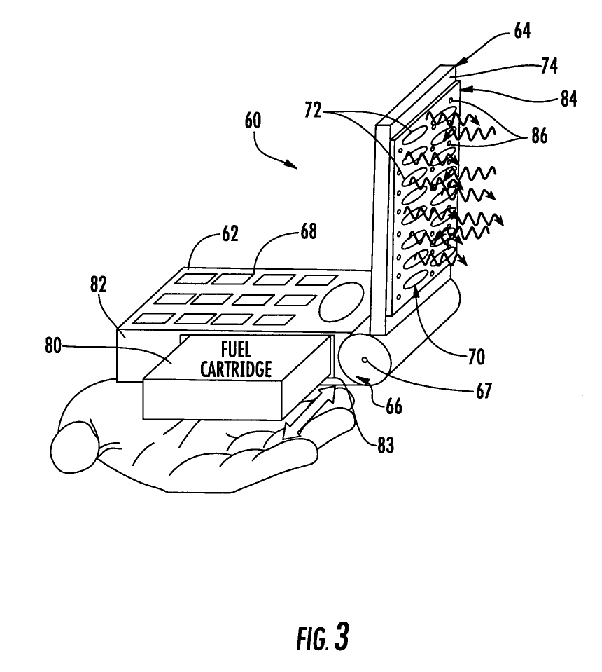

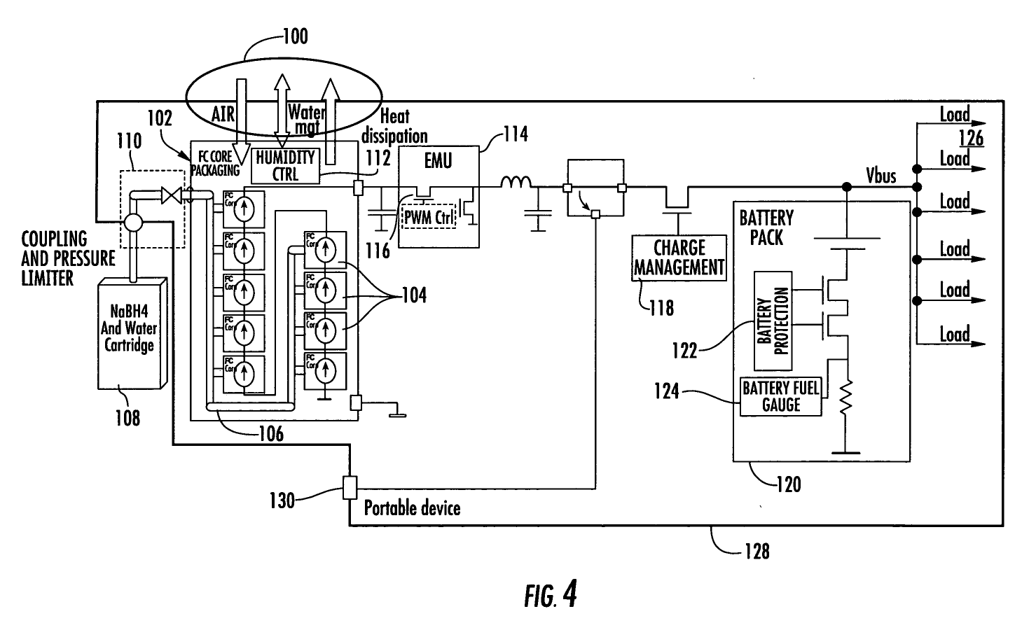

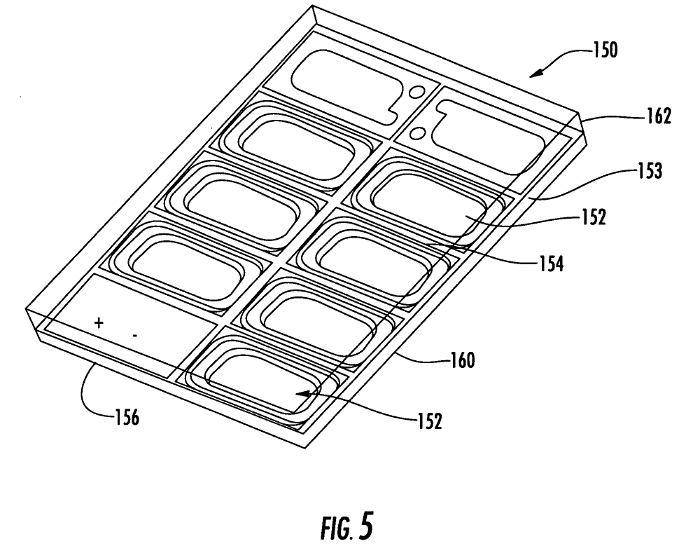

FIG. 3 is a perspective view of a portable electronic device 60 in accordance with a non-limiting example of the present invention. The portable electronic device 60 in this particular example is configured as a hand-held device that includes a base member 62 and a display member 64 that is pivotally mounted at the rear section 66 of the base member through an appropriate pivot mount 67. The base member 62 includes a keypad 68 or similar data entry device. As illustrated, a fuel cell unit 70 includes a number of fuel cell elements 72 as explained in greater detail below with an explanation relative to FIGS. 4 and 5. The fuel cell unit 70 is positioned on the rear side 74 of the display member 64, which is the top surface of the display when the display is folded down over the base member 62 and covering the keypad 68.

In this particular configuration, the anode is juxtaposed to the outside surface of the display, and the cathode faces outward therefrom to allow air breathing, heat dissipation and water management. The cathode forms an air breathing interface. A fuel source formed in this example as a fuel cartridge 80 is positioned at the side 82 of the base member 62. A supply tube or other feed arrangement (not shown in detail) extends from the fuel cartridge 80 to the anode. The fuel cartridge 80 can be slidably received into a cartridge adapter port 83, which facilitates easy replacement. The fuel cell unit 70 includes a protective housing 84, with appropriate air vents 86, shown as small dots, to allow air breathing, heat dissipation, and water management, for example, water to evaporate.

The fuel cell unit 70 is integrated as an assembly on the backside 74 of the display panel 64, and the cathode of the fuel cell unit is exposed as an air breathing interface, for example, from the air vents in the housing. The particular design of this fuel cell unit allows air breathing. The housing 84 is formed to protect the fuel cell against external shock through an appropriate construction, The proper humidity level at any fuel cell membrane used in the unit can be maintained during operation. The membrane will not dry-up when the fuel cell is not working. Of course, it should be understood that different portable electronic devices can be used besides the particular example shown in FIG. 3.

FIG. 4 is a schematic circuit diagram of an example of a system architecture that can be used with the ambient air interface 100 of a fuel cell unit 102 having a number of different fuel cell cores as different fuel cell elements 104 that receive fuel through a manifold system 106 that is connected to a fuel cartridge 108 in accordance with a non-limiting example as a NaBH4 fuel and water cartridge. A coupling pressure limiter 110 is connected between the cartridge 108 and the fuel cell core unit 102. This system also includes a humidity control module 112 as illustrated and operative with the different fuel cell elements 104. Air, water management and heat dissipation occur through the ambient air interface.

An electrical current is generated out of the fuel cell unit 102 through an EMU circuit 114 that includes a pulse width module (PWM) control switch 116 and various capacitors and electronic components. A charge management circuit 118 controls an auxiliary battery pack 120, which includes a battery protection circuit 122 and battery fuel gauge 124 as illustrated. The different circuits as loads 126 of the portable electronic device 128 to which this fuel cell unit 102 is integrated can be powered as illustrated. The current is returned as illustrated. An optional battery charge connection 130 on the device could be used to charge external batteries. The cartridge 108 is shown outside the device 128 since it can be removed, but when inserted into the device, it becomes integral therewith.

FIG. 5 is an isometric view of a silicon fuel cell unit 150 that could be used in accordance with a non-limiting example of the present invention. As illustrated, nine fuel cell elements 152 are shown and formed on a silicon substrate 153. The fuel cell elements can be connected by an appropriate fuel delivery system 154. An output electrical connection 156 is formed at one end. A planar mechanical support 160 is positioned on the underside and a housing 162 provides water management and mechanical protection as explained before. The nine fuel cell elements as illustrated can produce about 300 mW per centimeter squared (mW/cm²) with a stabilized theoretical potential of about 2.7 W. The fuel cell elements each include anode and cathode terminals, together can be serially connected. The entire unit is planar configured to attach to display member or other surface cell elements by appropriate techniques.

The silicon fuel cell could be manufactured following those techniques used for manufacturing fuel cell devices as set forth in commonly assigned and incorporated by reference U.S. Patent Publication Nos. 2003/0003347; 2004/0142214; and 2006/0073368. In some arrangements, it is possible to use a thermal-capillary pump operative with the electrodes and an ion exchange electrolyte, which is operatively connected to a fuel processor or similar device. The electrodes can be configured as planar configured members such that heat generated between any electrodes forces water to any cooler edges of the electrodes and can be pumped by capillary action in a thermal-capillary pump. A silicon substrate can be used to define electrodes and/or flow dividers and it is possible to divide an anode electrode and flow divider having a fuel gas input channel and other microchannels through which fuel gas can flow to engage the electrolyte. A cathode electrode and flow divider for the air/oxygen can be formed in a similar manner using a silicone substrate.

Typically, a solid polymer electrolyte is used and formed as a thin membrane or plastic film, and forms a polymer electrolyte membrane (PEM) fuel cell. Typically, the polymer electrolyte membrane can be a plastic-like film that ranges from about 50 to about 175 microns and can be formed from perfluorosulfonic acids and similar acids that are Teflon-like fluorocarbon polymers having side chains ending in sulfonic acid groups (—SO₃²). Representative, non-limiting examples of acid derivatives that can be used for the polymer include perfluorosulfonic acid and sold under the tradename “Nafion,” phenolsulfonic acid, polyethylene sulfonic acid, polytrifluorosulfonic acid, and similar compounds.

It is possible to use a solid fuel as a fuel preform, which reacts with water or water by-product from a fuel cell reaction to produce hydrogen and oxygen. Such solid fuels could also be formed as a gel, and manufactured by different companies, including Alternative Energy Conversion, Inc. of Canada. A solid fuel could react with water and could be formed as metallic, alloy component in which the increase or decrease of the hydrogen yield could be controlled by mixing various components. The solid fuel, for example, could be formed as an alloy tablet with different pH effecting chemicals. Hydrogen bubbles could bubble-out at a particular rate when mixed with a certain amount of water. Hydrogen could run a desired application on-demand. The solid fuel compounds could be formed from various alloys of zinc, aluminum and/or other materials that produce hydrogen upon contact with water, typically in a pH sensitive environment, for example, such as controlled by sodium hydroxide (NaOH) or similar agents as one non-limiting example. Water is provided by the fuel cell reaction, as a by-product from the fuel cell, and is evaporated. It is possible for capillary action to pump some water back to a fuel processor in some non-limiting examples. A fuel cell battery could be charged by adding drops of water into a fuel cell processor, if used.

It is possible that a fuel processor could be used as a renewable fuel operable as part of a regeneration process in which hydrogen is produced by the electrolysis of water. It is possible to use a solar charger. When hydrogen gas is produced in such units, it could be stored by absorption in a metal hydride or nano-tube matrix, as non-limiting examples. A thermal-capillary pump could be used in the system.

It is possible to use a low pressure flow divider design forming a diffuser and reactor of the fuel cell. A silicon substrate could have a formed flow divider for fuel gas and an anode electrode. Different and smaller fuel microchannels or gas flow tracts can branch-out from a primary fuel gas input channel to allow the fuel gas to diffuse throughout the anode electrode and an ion exchange electrolyte. Fuel gas input channels can be tapered to increase fuel gas velocity and enhance low pressure, diffusion flow of the fuel gas through defined microchannels.

Different silicon processing techniques described in the incorporated by reference published patent applications can be used. It is possible to use microelectromechanical (MEMS) valves at fuel gas input channels to regulate the flow of fuel gas into input channels. Of course, a MEMS valve could be a balanced beam, cantilever or other structure, forming a valve that could be controlled in various open positions. A MEMS controller can be connected to each MEMS valve to control actuation of the MEMS valve and control fuel gas flow into the fuel cell, Different heater and humidity or temperature sensors can be provided and operative with the fuel cell. For example, the humidity or temperature sensor circuit could work by measuring capacitance between different or two parallel conducting elements, and based upon the measured capacitance, initiate operation of a heater to initially start a reaction, which can take added heat provided by the heater. The heater, humidity sensor, and/or temperature sensor could be formed as MEMS circuits, using polysilicon as conductors depending on the design used and the type of silicon substrate and the manufacturing process. A MEMS controller could be used to control the heater and regulate power.

Of course the PEM could be formed as a gel or polymer that can be wiped onto a structure or using other modifications.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A portable electronics device, comprising:
a base member containing electronic circuitry for device operation and configured for handheld use;
a display member having a display operatively connected to and driven by said electronic circuitry, wherein said display member is pivotally connected to the base member and movable from a closed position and into an open position at which a user can view the display, and including a back side that is typically not handled by a user when the device is in use; and
a fuel cell unit secured to the back side of said display member and operatively connected to said electronic circuitry and display for powering said display and electronic circuitry, said fuel cell comprising an anode and cathode such that said anode is juxtaposed at the backside of said display member and said cathode is oriented outward from the backside facilitating unobstructed air breathing, evacuation of water and heat dissipation.

2. The portable electronics device according to claim 1, wherein said fuel cell unit comprises a plurality of fuel cell elements, each comprising an anode terminal.

3. The portable electronics device according to claim 2, wherein said fuel cell elements are serially or in parallel or a combination of parallel and serially connected.

4. The portable electronics device according to claim 1, wherein said fuel cell unit comprises an output electrical connection to which said display and electronic circuitry are connected.

5. The portable electronics device according to claim 1, wherein said fuel cell unit comprises at least one silicon substrate on which said cathode and anode are formed.

6. The portable electronics device according to claim 1, which further comprises a cartridge adapter port within said base member and configured for receiving a fuel cartridge as a fuel supply for supplying fuel to the fuel cell unit.

7. The portable electronics device according to claim 1, wherein said base member includes opposing sides and said cartridge adapter port is positioned on a side of said base member to facilitate manual insertion of a fuel cartridge.

8. The portable electronics device according to claim 1, which further comprises a keypad carried by said base member and operative with said electronic circuitry and display for entering characters that can be displayed.

9. The portable electronics device according to claim 8, wherein said keypad is covered and protected by said display member when in the closed position.

10. The portable electronics device according to claim 8, wherein said electronic circuitry, keypad and display are operative as a portable computer.

11. The portable electronics device according to claim 1, wherein said base unit includes a rear edge on which said display pivotally mounts.

12. A portable electronics device, comprising:
a base member containing electronic circuitry for device operation and configured for handheld use;
a display member having a display operatively connected to and driven by said electronic circuitry, wherein said display member is pivotally connected to the base member and movable from a closed position and into an open position at which a user can view the display, and including a back side that is typically not handled by a user when the device is in use;
a planar configured fuel cell unit secured to the back side of said display member and operatively connected to said electronic circuitry and display for powering said display and electronic circuitry, said fuel cell comprising a housing and a planar support and plurality of fuel cell elements supported thereon within the housing, each fuel cell unit having an anode terminal and cathode terminal forming an anode and cathode of the fuel cell such that said anode is juxtaposed at the backside of said display member and said cathode is oriented outward from the backside facilitating unobstructed air breathing, evacuation of water and heat dissipation, wherein said housing has vent openings to facilitate air ingress, water evacuation and heat dissipation; and
a fuel supply carried by said base member and operatively connected to said fuel cell unit for supplying fuel to said fuel cell unit.

13. A portable electronics device according to claim 12, wherein said fuel cell elements are serially or parallel or a combination of parallel and serially connected.

14. A portable electronics device according to claim 12, wherein said fuel cell unit comprises an output electrical connection to which said display and electronic circuitry are connected.

15. A portable electronics device according to claim 12, wherein said fuel cell unit comprises at least one silicon substrate on which said cathode and anode are formed.

16. A portable electronics device according to claim 12, which further comprises a cartridge adapter port within said base member and configured for receiving a fuel cartridge as the fuel supply for supplying fuel to the fuel cell unit.

17. A portable electronics device according to claim 16, wherein said base member includes opposing sides and said cartridge adapter port is positioned on a side of said base member to facilitate manual insertion of a fuel cartridge.

18. A portable electronics device according to claim 12, which further comprises a keypad carried by said base member and operative with said electronic circuitry and display for entering characters that can be displayed.

19. A portable electronics device according to claim 18, wherein said keypad is covered and protected by said display member when in the closed position.

20. A portable electronics device according to claim 19, wherein said electronic circuitry, keypad and display are operative as a portable computer.

21. A portable electronics device according to claim 12, wherein said base unit includes a rear edge on which said display pivotally mounts.

22. A method of operating a portable electronics device, which comprises:
providing a base member containing electronic circuitry for device operation and configured for handheld use;
providing a display member that is pivotally connected to the base member and movable from a closed position and into an open position at which a user can view the display, wherein the base member includes a back side that is typically not handled by a user when the device is in use;
powering the display and electronic circuitry from a fuel cell unit on the back side of the display member, wherein the fuel cell unit comprises an anode and cathode such that said anode is juxtaposed at the backside of the display member and the cathode is oriented outward from the backside facilitating unobstructed air breathing, evacuation of water and heat dissipation; and
supplying fuel to the fuel cell unit from a fuel source that is supported by the base member.

23. The method according to claim 22, which further comprises forming the fuel cell unit as a plurality of fuel cell elements, each comprising an anode terminal and cathode terminal.

24. The method according to claim 23, which further comprises serially connecting each of the fuel cell elements.

25. The method according to claim 22, which further comprises forming the fuel cell unit on a silicon substrate.
